(19) United States
(12) Patent Application Publication
(10) Pub. No.: US 2002/0143575 A1
(43) Pub. Date: Oct. 3, 2002

(54) Interpretation system and method for multi-threaded event logs

(75) Inventors: Carl Harold Hansen, Latham, NY (US); Bruce Douglas Pomeroy, Duanesburg, NY (US)

Correspondence Address: GENERAL ELECTRIC COMPANY, CRD PATENT DOCKET ROOM 4A59, P O BOX 8, BUILDING K 1 SALAMONE, SCHENECTADY, NY, 12301, US

(73) Assignee: General Electric Company

(21) Appl. No.: 09/781,517

(22) Filed: Feb. 12, 2001

(51) Int. Cl. G06F 17/60

(52) U.S. Cl. 705/2; 705/3

(57) ABSTRACT

A system and method for automatically interpreting a multi-threaded event log. A medical imaging device such as a magnetic resonance (MR) or computed tomography (CT) device records imaging data correlating to medical examinations. The imaging data is stored in an event log along with other data such as system errors and table movement. Certain useful information must be extracted from the event logs to provide useful reports for clinician review or further processing. The present system incorporates a state machine to extract useful information based on predefined conditions. The useful information is automatically extracted from the event log and stored in a reduced data set event log.

### BACKGROUND OF THE INVENTION

1. Field Of The Invention

The present invention relates generally to the field of medical diagnostic systems, such as imaging systems of various modalities. More particularly, the invention relates to a system and method for interpreting multi-threaded event logs produced by imaging systems.

2. Description of the Related Art

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Medical diagnostic and imaging systems are ubiquitous in modem health care facilities. Such systems provide invaluable tools for identifying, diagnosing, and treating physical conditions, and they greatly reduce the need for surgical diagnostic intervention. In many instances, final diagnosis and treatment proceed only after an attending physician or radiologist has completed conventional examinations with detailed images of relevant areas and tissues via one or more imaging modalities. Currently, a number of modalities exist for medical diagnostic and imaging systems. These include computed tomography (CT) systems, x-ray systems (including both conventional and digital or digitized imaging systems), magnetic resonance imaging (MRI) systems, positron emission tomography (PET) systems, ultrasound systems, nuclear medicine systems, and so forth. In many instances, these modalities compliment one another and offer the physician a range of techniques for imaging particular types of tissue, organs, physiological systems, and so forth. Health care institutions often dispose several such imaging systems at a single facility or at multiple facilities, thus permitting its physicians to draw upon such resources as required by particular patient needs.

Modem medical diagnostic systems typically include circuitry for acquiring image data and for transforming the data into a usable form which is then processed to create a reconstructed image of features of interest within the patient. The image data acquisition and processing circuitry is often referred to as a “scanner” regardless of the modality, because some sort of physical or electronic scanning generally occurs in the imaging process. The particular components of the system and related circuitry differ greatly between modalities due to their different physics and data processing requirements.

Each scanner generally includes a multiprocessing operating system, such as Unix, which permits one or more independent programs to run on the scanner simultaneously. For instance, one program may interact with a machine operator, while another program controls the scanner hardware, and still other programs monitor the health of the equipment. Each of these programs may produce data which is stored in the scanner. Each stream of data produced by an application may be referred to as a “thread.”

Medical diagnostic systems of the type described above are often called upon to produce reliable and understandable images and reports within demanding schedules and over a considerable useful life. As discussed above, a medical diagnostic system or scanner is generally capable of storing data acquired from different programs and testing procedures. After a period of time, such as two or three days, the information stored on the scanner is transferred from the scanner to an alternate location such as a local database or analysis center for further processing. Each data set removed from a scanner over a particular period of time may be referred to as an event log. Each event log may be described as “multi-threaded” since it includes a plurality of threads, each thread including a information such as medical imaging data, system error data, table movement data, etc.

Generally, the resulting event log is interpreted by humans. The imaging data associated with each scan can be extracted from the event log manually by a clinician, for example. However, human intervention is often time consuming and precludes a streamlined automated process for interpreting medical imaging data.

The present invention may address one or more of the concerns set forth above.

### SUMMARY OF THE INVENTION

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

In accordance with one embodiment of the present invention, there is provided a method of producing a reduced data set event log comprising the acts of monitoring an event log, comprising examination and series data from a digital imaging device; and automatically copying portions of the examination and series data from the event log to produce the reduced data set event log.

In accordance with another aspect of the present invention, there is provided a method of interpreting an event log comprising the acts of using a state machine to describe predetermined conditions switching states of the state machine in response to the detection of the predetermined conditions; and producing a reduced data set event log based on the output of the state machine.

In accordance with yet another aspect of the present invention, there is provided a method for defining conditions for producing a reduced data set event log comprising manually inspecting exemplary event logs comprising examination records and series records; identifying a plurality of conditions corresponding to the examination records and series records; and using each of the conditions to define a state machine.

In accordance with a further aspect of the present invention, there is provided a system for interpreting an event log comprising an input device configured to produce an event log, the event log comprising imaging data correlative to an image scan; and a feature extracter module configured to receive the event log from the input device and further configured to produce a reduced data set event log.

In accordance with still another aspect of the present invention, there is provided a system for interpreting an event log comprising a computer comprising a feature extracter module, the module configured to receive an event log from an input device and further configured to produce a reduced data set event log.

In accordance with yet a further aspect of the present invention, there is provided a feature extracter module configured to receive an event log from an input device and further configured to produce a reduced data set event log.

In accordance with still another aspect of the present invention, there is provided a computer-readable medium storing computer instructions for monitoring an event log comprising examination and series data from a digital imaging device; and automatically copying portions of the examination and series data from the event log to produce a reduced data set event log.

In accordance with still a further aspect of the present invention, there is provided a tangible medium for storing a state machine comprising a routine for switching states of a state machine in response to the detection of the predetermined conditions; and producing a reduced data set event log based on the output of the state machine.

### BRIEF DESCRIPTION OF THE DRAWINGS

The foregoing and other advantages of the invention will become apparent upon reading the following detailed description and upon reference to the drawings in which:

FIG. 1 illustrates a block diagram of an exemplary medical facility and servicing system in accordance with the present technique;

FIG. 2 illustrates a block diagram of one embodiment of the present technique incorporated into an automated reporting system;

FIG. 3 illustrates an exemplary embodiment of a medical imaging device containing an event log;

FIG. 4 illustrates an exemplary embodiment of a state machine in accordance with the present technique; and

FIG. 5 illustrates a portion of a reduced data set event log in accordance with the present technique.

### DETAILED DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

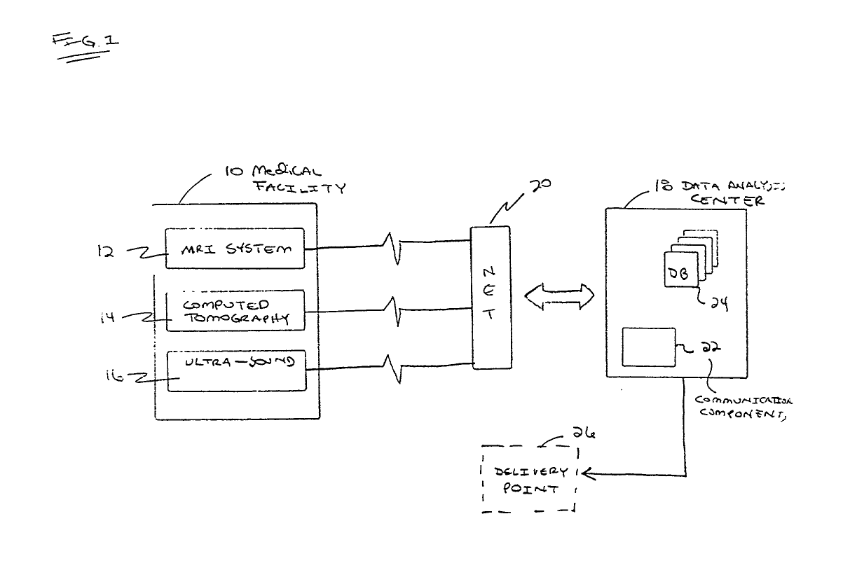

With the large volumes of imaging data, it is becoming increasingly important to automate as much of the imaging data analysis as possible, because manual analysis slows the analysis process. The embodiment described with reference to FIG. 1 illustrates an exemplary medical facility and an exemplary technique for gathering data from an event log with minimal human intervention. This particular medical facility 10 includes a plurality of scanners, such as an MRI system 12, a computed tomography (CT) system 14, and an ultrasound system 16. These and other modalities may produce event logs which are analyzed to provide clinicians and other personnel with useful imaging data. To facilitate this process, a data analysis center 18 may be linked to the medical facility via a remote access network 20. It should be understood, however, that any suitable network connection may be employed. Presently, advantageous network configurations may include proprietary and dedicated networks as well as open networks, such as the Internet.

The data analysis center 18 may be located locally or remotely with reference to the medical facility 10. The analysis center 18 may include communication components 22, such as a network computer, which are configured to receive the communications from the medical facility 10, and more specifically from the scanners such as the MRI system 12, the CT system 14, and the ultrasound system 16. The communication components 22 may comprise a device such as a computer which is used to implement the present system. The computer may include a software routine to implement the present technique or may include one or more memory devices which are encoded to implement the present technique. The communications components 22 may be linked to one or more databases 24. The databases 24 may include information on operating parameters, service histories, and so forth which are reserved for specific scanners and specific medical facilities 10, as well as external populations of diagnostic equipment. The data analysis center 12 may be responsible for parsing the event logs from the medical facility 10 and sending some output to a delivery point 26. The delivery point 26 may be a location within the medical facility 10, in which case the output from the data analysis center is generally a user readable report or reduced data set event log comprising certain data. However, the delivery point 26 may be simply an internal point within the data analysis center 12. In this case, the output may be an internal data set which is delivered to another portion of the analysis center for further processing. This concept will be further discussed below.

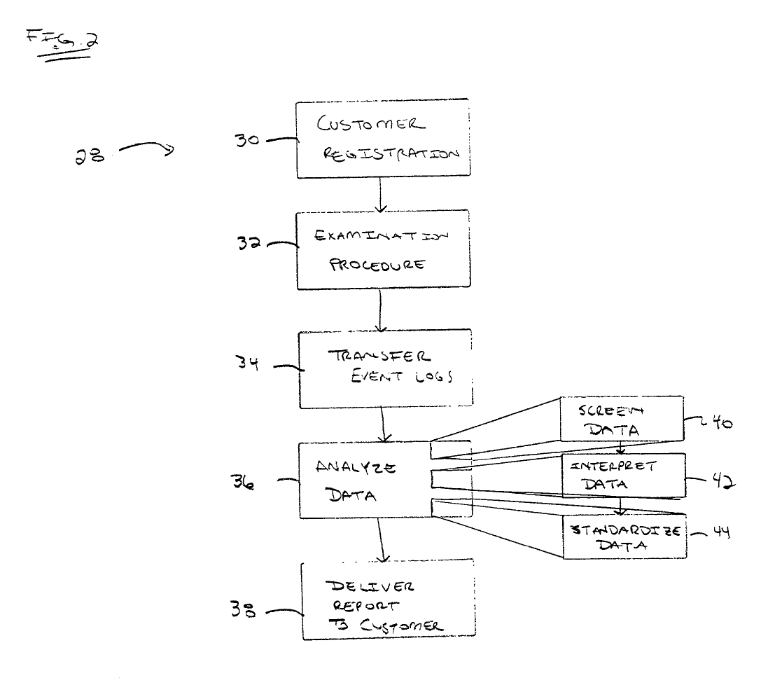

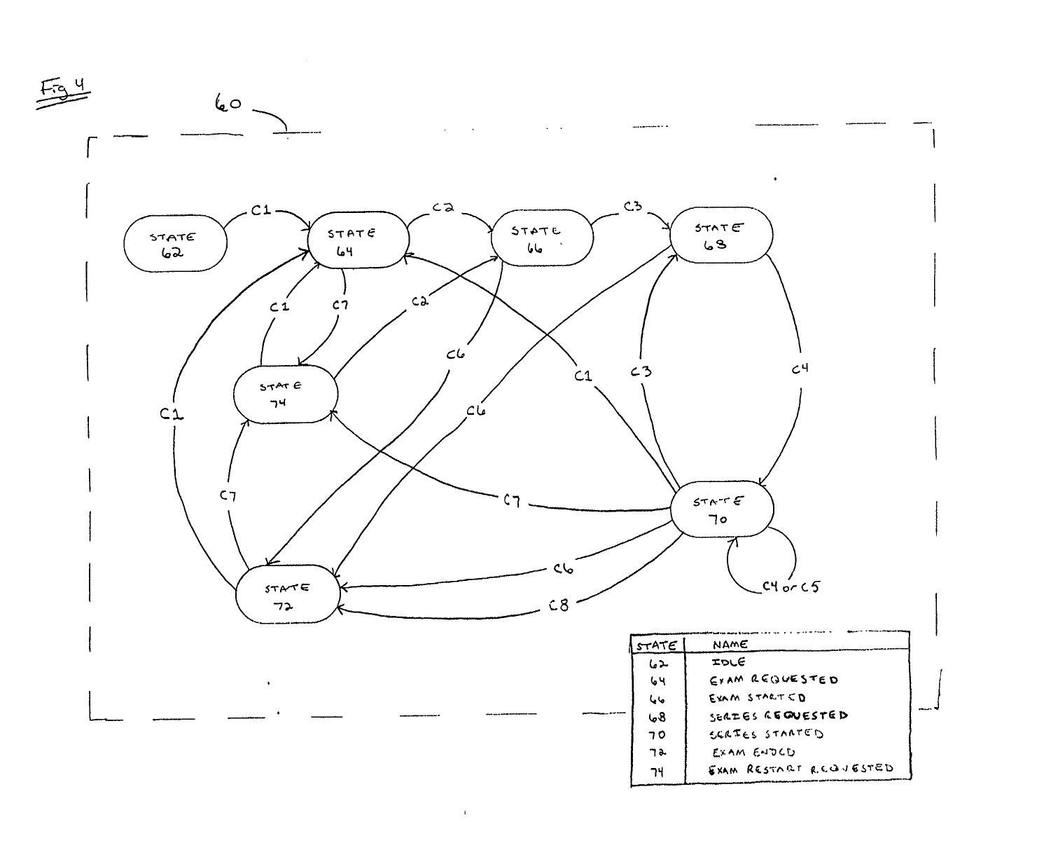

FIG. 2 illustrates a block diagram of the present technique incorporated into one embodiment of an automated system. This exemplary process is generally illustrated by reference numeral 28 and should be viewed in conjunction with FIG. 1. It is important to understand the block diagram illustrated in FIG. 2 depicts one possible implementation of the technique which will be described further herein with reference to FIG. 4. This particular application depicts a fully automated system in which one or more reports are produced based on the data received from scanners 12, 14, and 16 in a medical facility 10. Alternatively, the present technique may be implemented independently such that data is taken from a scanner 12, 14, or 16 and delivered to a local computer for interpretation.

Initially, a customer, such as an administrator or other medical personnel from a medical facility 10, may register with an agent or representative of the analysis center 18 (as in block 30). Among the preliminary tasks associated with customer registration, the customer may prepare a facility profile which describes the scanners 12, 14, and 16 within the medical facility 10 as well as demographic, geographic, and/or business characteristics of the facility 10. Further, the customer may complete a report profile which may be used by the analysis center 18 to determine the type of reports and the formats of the final reports. The report profile may also indicate what type of peer comparison data that each medical facility 10 desires. Once the profiles have been stored in the system at the analysis center 18, one or more databases 24 are configured to store and maintain the data used for preparing each report. Data may be archived to create historical databases which may be used for peer comparisons through the reporting process.

After the profiles are established, they are used to generate particular report formats for each subscriber. The reports will be generated using these formats which are stored in the database 24 under each subscriber. Since the report formats (which are based on the report profile) are stored in the database 24, the analysis center 18 simply waits for the automatic receipt of the data from the medical facility 10 and automatically inserts the data and information into the current format assigned to each report. These profiles are initially delivered by the subscribing medical facility 10 to the analysis center 18. Further, each scanner 12, 14, and 16 associated with a subscribing facility 10 is linked to the analysis center 18 by a network 20 such as a remote access network.

After a customer has registered (block 30), the analysis center 18 is ready to receive data from an examination procedure. The examination procedure is generally indicated by block 32. During the examination procedure, a patient undergoes an imaging procedure, such as an MRI or CT procedure. During an examination, both the MRI and CT operating software generates and saves files containing examination information such as imaging parameters, examination codes, and date stamps to be used in preparing reports generated by the analysis center. Each scanner has a disk management strategy which is configured to retain data files in an “event log” until they are transferred to the analysis center.

Once the preliminary registration and linking is performed to establish a network link between a medical facility scanner and the analysis center, a plurality of examination data logs, also known as an event log, are automatically transferred periodically to the analysis center as indicated at block 34. Event logs are acquired from each of the digital imaging devices and the transfers are performed automatically and require little or no human intervention beyond the registration procedure, unless there are system failures. Thus, each scanner may be configured to automatically deliver event logs twice each week, for instance. Alternatively, the communication components 22 may be configured to automatically request data from the scanners. The frequency of this transfer may be selected or altered to avoid overflow of the scanner data storage media, for example. The transfer software may be configured to establish expected arrival frequency for each customer scanner and send an alert to an appropriate personnel when a scanner appears to have dropped offline.

As previously described, each event log may comprise concatenated data from many programs and examination procedures. Each stream of information stored in the event log may be referred to as a thread. Thus, a scanner produces a multi-threaded event log. Aside from information corresponding to a particular procedure, the event log may include a variety of other information such as system errors, table/gantry movement, image processing/viewing information, etc. While this information may be useful to individuals interested in error detection and system diagnostic information, this type of information may not be useful to clinicians who are interested in viewing clinical imaging data only. It may be advantageous to produce an event log containing a reduced set of threads.

Once the event log is received at the analysis center 12, it is analyzed, as indicated by block 36. The analysis process may facilitate providing a customer report in accordance with a report profile established for each customer and may compute requested performance criteria such as exam volume or scanner utilization and productivity, and so forth. A specific report profile may require that the examination data be analyzed and correlated with data from other scanners or other facilities. The results may be displayed in a variety of formats including time series, pie charts, and bar charts, for instance, as specified in each customer report profile. Once the data is analyzed and the reports are prepared, the reports may be delivered to a customer in accordance with a pre-established schedule as indicated by block 38. The reports may be delivered in a predetermined format specified in the report profile. The customer may receive reports as a mailed hard copy, a fax, static pages that may be viewed through an internet browser, or any other mutually acceptable format.

During the analysis of the data (indicated by block 36) the data may be screened and interpreted as indicated by blocks 40 and 42. Further, after the data is screened (block 40) good data may be standardized, as in block 44, such that it may be used to provide meaningful data for comparisons across scanners or across departments. During the screening process, block 40, the event logs may be evaluated against several criteria. For instance, the logs may be scanned for missing exams to determine if the file contains all of the exams that should have been acquired from each scanner in a period during this particular examination. This may be answered by comparing the exams seen in new files with those already in the facility history database. Also, a file may be screened to determine if there are missing fields critical to the reporting within a given event log. It should be clear that other criteria may be used to screen the incoming data. If, after the screening process, missing or corrupted data are detected, an error flag may be sent to personnel at the data analysis center and/or the data may be rejected. Service representatives at the analysis center can determine an appropriate course of action based on the type of failure.

If, on the other hand, all of the incoming data in the event logs passes the screening process, the data may be interpreted (block 42) and standardized (block 44). The data interpretation (block 42) will be further discussed with reference to FIG. 4, below. The data may be standardized (block 44) to categorize the exams in a manner that is significant to the recipients of the reports and consistent across all scanners in the database. Standardization is required for data fields that are typed by scanner operators; a simple example is patient sex which may be entered as M/P or male/female. Thus all entries of M should be grouped with all entries of male since they correspond with the same category patient. Further, certain data from the event logs is generally free text data which may also be standardized by any process available. This standardization process is beyond the scope of this application.

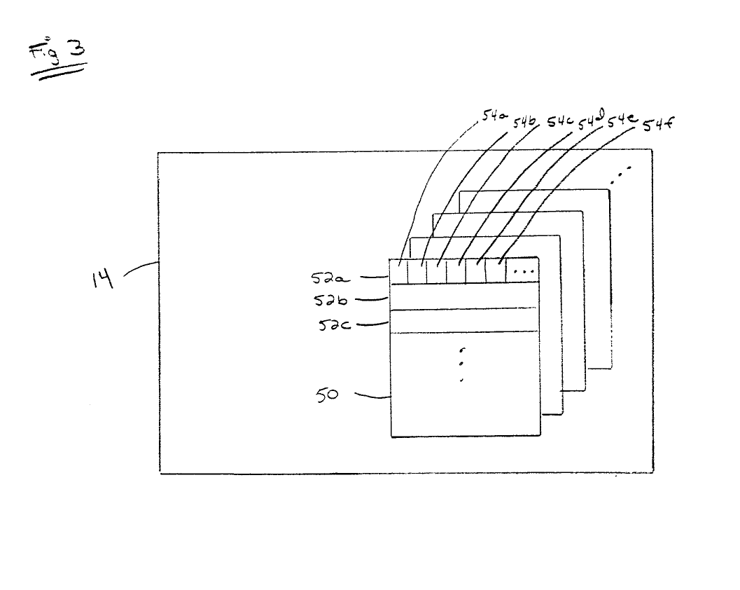

FIG. 3 illustrates one example of a medical imaging device containing an event log file with stored examination records, each examination record including several series records. Specifically, a CT system 14 is illustrated. Once a medical examination is performed on a patient using the CT system 14, data is acquired and stored in an event log file 50 which may be a storage area within the CT system 14. The data acquired for each examination procedure is stored as an examination file such as examination records 52a, 52b, and 52c. Each examination record 52a, 52b, and 52c contains numerous fields for each exam such as an exam description, event start time, patient information, and various series records. Series records for the examination record 52a are generally illustrated by reference numerals 54a-f. Each series record 54a-54f may include information such as series date, series start time, and scan protocol, and the like. Periodically, the CT system 14 will automatically transmit an event log file 50 containing many examination records 52a-c to the analysis center 18 for report preparation as discussed with reference to FIG. 1 and 2.

FIG. 4 illustrates a state machine which may be used to interpret an event log (block 42, FIG. 2) in accordance with the present technique. In one advantageous embodiment, the state machine is implemented through a software algorithm. However, the state machine may also be implemented through hardware such as a programmable memory device (e.g. a Programmable Read Only Memory (PROM)). A state machine simply refers to a set of structured conditions which trigger the movement of a process from one state to another. Specifically, with reference to FIG. 4, the state machine describes the conditions which trigger certain actions to be taken in interpreting the multi-threaded event log to produce a reduced data set event log.

Initially, an event log, such as the event log shown in Appendix 1 will be delivered from a scanner to a location in which an analysis can take place such as data analysis center 12 in FIG. 1. The exemplary event log illustrated in Appendix 1 corresponds to a CT scanner. As can be seen with reference to Appendix 1, the event log may include multiple threads of information such as date and time of certain events, references to the event which occurred, and certain errors which may occur in the system. From manual inspection of sampled event logs, a state machine as illustrated in FIG. 4 can be derived. Here, the event log produced by the CT scanner has been manually analyzed and certain conditions which correspond to different events have been implemented for interpreting the event log automatically through the state machine. This manual training process will define the conditions which are used in the state machine. An example of the output of the state machine, the reduced data set event log, is illustrated in Appendix 2. Both Appendix 1 and Appendix 2 are discussed below with reference to FIG. 4.

The state machine may be referred to generally as a feature extracter module 60. A discussion on how the module 60 generally functions will be followed by a more specific implementation of the module 60, with respect to the present technique by application of the feature extracter module 60 to a specific event log such as the event log illustrated in Appendix 1.

Initially, the feature extracter module (FEM) 60 is idle, as in state 62. Here the FEM 60 is initialized and remains idle waiting for a condition to trigger movement to the next state. As the FEM 60 begins to interpret an event log (such as event log 50), the FEM 60 reads each successive line of the event log and searches for a condition C1 which is a command string indicating the beginning of an examination record (such as examination record 52a) within the event log. Once a condition C1 is found, the FEM 60 transitions from the idle state 62 to state 64 indicating that the FEM 60 has detected the start of a new examination file within the event log.

As the FEM 60 continues interpreting the event log, it will search for a condition C2. Condition C2 indicates the receipt of information which should be stored in the reduced data set event log. Thus, once a condition C2 is encountered, information will be extracted from the event log and saved in the reduced data set event log, as will be further discussed in the specific implementation described below. After extracting the information, the FEM 60 transitions from state 64 to state 66 where it remains until detecting a condition C3.

A condition C3 indicates that the FEM 60 has encountered the start of a new series record (such as series record 54a). Once the condition C3 is encountered, the FEM transitions to state 68. The FEM 60 will remain in state 68 until a condition C4 is received.

A condition C4 indicates the detection of information from the series record that should be recorded in the reduced data set event log. Condition C4 is similar to the condition C2 in that it represents a flag that information which should be stored in the reduced data set event log has been encountered and should be recorded. As the FEM 60 residing in state 68 receives condition C4, the FEM 60 transitions to state 70. The FEM 60 will remain in state 70 as long as it receives other condition C4 flags or if it receives a C5 condition flag which indicates multiple scans in a single series. While in state 70, if the FEM 60 encounters condition C3, this will indicate that another series record (such as series record 54b) has been encountered within a particular examination record and thus the FEM 60 will transition back to state 68. Thus, the FEM 60 will remain in state 70 extracting information while detecting a C4 or C5 condition within a single series, and the FEM 60 will switch back to state 68 upon receipt of additional series records within an examination record upon detection of condition C3.

The FEM 60, residing in state 70, will switch to state 72 upon detection of a condition C6 which indicates the end of a particular examination record. The FEM 60 will remain in state 72 until a condition C1 is encountered indicating a new examination record (such as examination record 52b) has been encountered, or condition C7 indicating that a previously encountered examination record is to be modified by adding new series.

When the FEM encounters condition C7 while residing in state 72, the FEM 60 will transition to state 74. From state 74, if a condition C1 is encountered, this indicates that a new exam has been started, and thus the FEM 60 will transition to state 64 and the current process will begin again. If, while residing in state 74, the FEM 60 encounters state C2, this will indicate that new series are about to be added to a previous exam, and the FEM 60 will transition to state 66.

Aside from the typical flow through the states of the FEM 60 as discussed above, certain other conditions may cause transition out of the normal flow. For instance, event C8 from state 70 can occur when the scanner is reset during an exam due to technical difficulties. The summary below describes each condition that will cause transition from the given state. Any other conditions or data encountered in an event log while the FEM 60 is in the given state will result in no transition to a new state.

The FEM 60 will remain in state 64 until either condition C2 or C7 is encountered in the event log. If condition C2 is encountered, this indicates the beginning of a new examination record (as previously discussed) within the event log and the FEM 60 transitions to state 66. If condition C7 is encountered, the FEM 60 will transition to state 74 indicating that new series records will be added to an existing exam record.

The FEM 60 will remain in state 66 until it encounters either condition C3 (as previously discussed) or C6. Condition C3 indicates the beginning of a new series record and will transition the FEM to state 68. Condition C6 indicates the end of an examination record or an event log which will transition the FEM 60 to state 72.

The FEM 60 will remain in state 68 until either a condition C4 (as previously discussed) or C6 is encountered. A condition C4 indicates that recordable information within a series record has been detected and will be recorded on the reduced data set event log. The FEM 60 transitions to state 70. A condition C6 indicates the end of an examination record or the event log and will transition the FEM 60 to state 72.

The FEM 60 will remain in state 70 until conditions C1, C3 (as previously discussed), C6 (as previously discussed), C7, or C8 are encountered. Condition C3 indicates the start of a new series record within the present examination file and transitions the FEM 60 back to state 68. Condition C6 indicates a normal end to a particular examination record and transitions the FEM 60 to state 72. Condition C1 indicates the start of a new examination record and transitions the FEM 60 back to state 64. This may indicate an abortion of a particular sequence and the start of a new patient examination. Condition C7 indicates that during an examination procedure, a clinician terminated the exam, and will be adding new series to an old exam record. The C7 condition indicates that the operator aborted but later decided to add scans to the series record that was previously recorded. In other words, the C7 condition is encountered when an examination is terminated prematurely but later completed. The C7 condition indicates the detection of completion data. While in state 70, if a condition C7 is encountered, the FEM 60 transitions to state 74. Finally, if a C8 condition is encountered, indicating a hard abort during an examination (caused by an event such as a machine shut down), the FEM 60 transitions to state 72.

The FEM 60 remains in state 72 until condition C1 or C7 (as previously discussed) is encountered. If condition C1 is encountered, this indicates the beginning of a new exam record and the FEM 60 transitions to state 64. If condition C7 is encountered, this indicates that new series records are about to be added to an old exam. In this case, the FEM 60 will transition to state 74.

The FEM 60 will remain in state 74 until either a condition C1 or C2 is encountered. If a condition C1 is encountered, indicating that a new examination has been detected, the FEM 60 transitions to state 64. If a condition C2 is encountered, indicating the new series are about to begin, the FEM 60 transitions to state 66.

For a specific implementation of the FEM 60, an event log from a CT scanner 14 (FIG. 1), such as the event log indicated in Appendix 1 can be used. Table 1 below indicates exemplary text strings representing the various conditions discussed above with reference to FIG. 4. The specific implementation will also reference Appendix 2 which illustrates an exemplary reduced data set event log.

TABLE 1
Feature Extracter Module Conditions

| Condition | Text |
|---|---|
| C1 | COMMAND_: Registration |
| C2 | MEASURE_: Registration Patient id |
| C3 | COMMAND_: MODE/TOPO |
| | COMMAND_: MODE/TOMO |
| | COMMAND_: TOPO/NEXT |
| C4 | MEASURE_: MODE Tomo |
| | MEASURE_: MODE Topo |
| C5 | MEASURE_: AUTO scan |
| | MEASURE_: START topogram |
| | MEASURE_: START tomogram |
| C6 | COMMAND_: REGISTRATION/END |
| C7 | COMMAND_: REGISTRATION/MODIFY |
| C8 | COMMAND_: RESET |

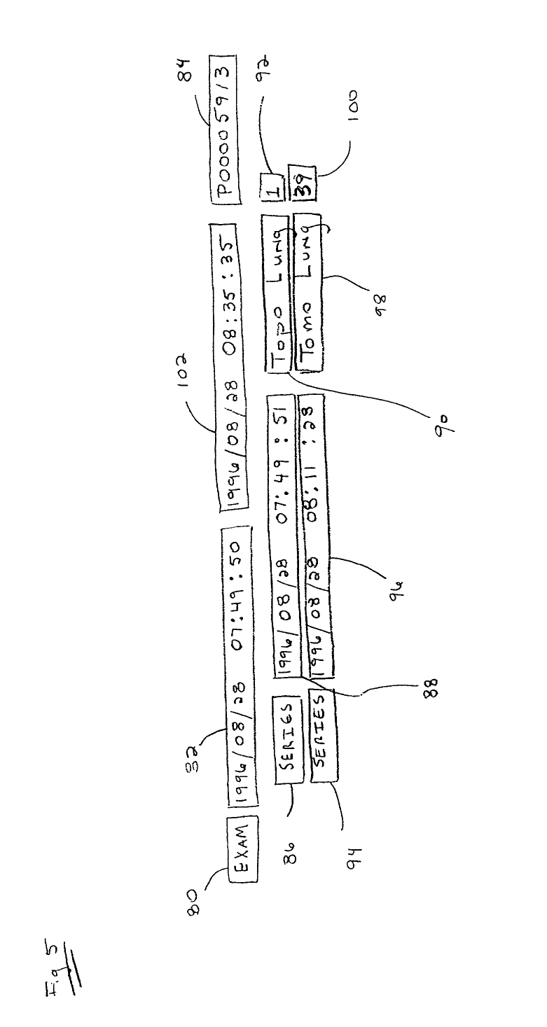

As previously discussed, the FEM 60 is initially in state 62. As an event log such as the event log illustrated in Appendix 1 is received by the FEM 60 for interpretation, the FEM 60 reads the event log until it detects a condition C1. In accordance with the example illustrated in Table 1, the text string corresponding to a condition C1 is “COMMAND_{—}1* REGISTRATION.” Line 1 of the event log in Appendix 1 contains the appropriate condition C1 to transition the FEM 60 from state 62 to state 64. While in state 64, the FEM 60 will receive line 2 of the event log for interpretation. Because line 2 does not contain any of the predefined conditions that will cause the FEM 60 to transition from state 64 to another state, the FEM 60 will remain in state 64 and move on to the next line (line 3) of the event log. In accordance with Table 1, line 3 contains condition C2 (MEASURE_{—}1: Registration Patient id). This condition will cause the FEM 60 to transition from state 64 to state 66. Also, the FEM 60 will extract the start date and time from line 3 and store the information in the reduced data set event log illustrated in Appendix 2. While Appendix 2 is an accurate depiction of a reduced data set event log corresponding to the event log in Appendix 1, for simplicity the first three lines of the first examination record contained in the reduced data set event log are illustrated in FIG. 5 with the various fields designated by reference numbers for the purpose of this discussion. However, Appendix 2 is illustrative of the more complete reduced data set event log.

Referring now to FIG. 5, an illustrative embodiment of the various fields in a portion of the reduced data set event log shown in Appendix 2 is illustrated. When the FEM 60, residing in state 64, received condition C2 a flag was initialized in the FEM 60 indicating that information on that line must be extracted from the event log and inserted into the reduced data set event log illustrated in FIG. 5. Upon receipt of condition C2, a text string EXAM is stored in field 80 (FIG. 5) indicating the beginning of a new examination record. The start date and time of the examination record are extracted (i.e. copied) from line 3 of the event log in Appendix 1 and inserted in field 82 of the reduced data set event log illustrated in FIG. 5. Further, the patient ID is extracted from line 3 and stored in field 84.

With the FEM 60 residing in state 66, line 4 of the event log in Appendix 1 is received and interpreted. Since the text string COMMAND_{—1: MODE/TOPO was assigned to condition C3 as illustrated in Table} 1, the FEM 60 transitions from state 66 to state 68. The condition C3 indicates the start of a new series record. Accordingly, the FEM 60 inserts the text string SERIES into field 86 of the reduced data set event log as illustrated in FIG. 5. The start date and time are extracted from line 4 and stored in field 88.

Next, the FEM 60, residing in state 68 receives and interprets line 5 of the event log illustrated in Appendix 1. Line 5 contains the text string corresponding to condition C4 as shown in Table 1. The FEM 60 transitions from state 68 to state 70. Further, the examination protocol, here “Topo Lung” is extracted from line 5 and stored in field 90 as illustrated in FIG. 5.

The FEM 60, residing in state 70, continues to read and interpret the event log searching for one of the conditions previously discussed which will cause the FEM 60 to transition to another state. In the event log illustrated in Appendix 1, lines 6, 7, and 8 do not contain text strings corresponding to any of the pre-defined conditions. Line 9, contains the text string corresponding to condition C5 indicating a scan procedure within a particular series record. In this example, the number of scans within a particular series record is preferably retained. Thus, upon receipt of condition C5 while in state 70, the FEM 60 will increment a counter to retain the number of scans contained within a particular series record. As will be seen, there is only one scan associated with this particular series record. As a result, a “1” is inserted into field 92 of the reduced data set event log illustrated in FIG. 5. The scan counter which is incremented for each scan performed in a particular series and stored in a field such as field 92 will be more easily understood with reference to the next series record.

The FEM 60 continues residing in state 70 until one of the pre-defined conditions is detected and will cause a transition to another state. Lines 10-13 do not contain any of the pre-defined conditions to cause a transition. Line 14, contains the text corresponding to condition C3 as illustrated in Table 1 which will cause the FEM 60 to transition from state 70 to state 68. The text string “SERIES” is stored in field 94 indicating the start of a new series within the exam record. Further, the starting date and time are extracted from line 14 and inserted in field 96.

Next, the FEM 60, residing in state 68, receives line 15 for interpretation. Because line 15 contains the text string associated with condition C4 as illustrated in Table 1, the FEM 60 will transition from state 68 to state 70. Further, the protocol text “Tomo Lung” will be extracted from line 15 and stored in field 98 of the reduced data set event log as illustrated in FIG. 5.

Lines 16-18 do not contain any of the pre-defined conditions that will transition the FEM 60 from its current state 70. Line 19 contains the text string corresponding to condition C5 as illustrated in Table 1. This event signals the first scan of the Lung series. Accordingly, the scan counter for this series record will be incremented by 1.

Continuing through the event log, the next significant entry is line 30 which contains the text string corresponding to condition C5, according to Table 1. This begins a group of 48 Auto Scan events. The scan counter for this series record will be incremented for each Auto Scan record that is encountered. Continuing through the log, a group of 4 additional manual scans is encountered at record 83. The scan counter will record 43 scans in this particular series as indicated by each detection of a condition C5. This scan count is stored in field 100 of the reduced data set event log illustrated in FIG. 5.

The FEM 60 will continue to receive and interpret each line of the event log illustrated in Appendix 1 and extract any information for storage in the reduced data set event log illustrated in FIG. 5. In the event log illustrated in Appendix 1, the next line containing a text string which will transition the FEM 60 out of its current state 70 is line 108. Line 108 contains the text string corresponding to the command C6 as shown in Table 1. The FEM 60 will transition from state 70 to state 72 and extract the end date and time corresponding to the completion date and time of this particular examination record and store the information in field 102 of the reduced data set event log illustrated in FIG. 5.

While the exemplary embodiment of the present FEM 60 illustrates a state machine which transitions in accordance with pre-defined conditions such as those specified in Table 1 in response to the receipt of a CT event log from a CT scanner, it should be understood that other conditions may be defined to trigger movement between states of the FEM 60. The transitions may be in response to a different type of CT event log or an event log from a different type of scanner such as an MR scanner. Further, the output of the FEM 60 (the reduced data set event log illustrated in FIG. 5 and further illustrated in Appendix 2) may include any information which is desirable for report generation and use by a clinician or for continued processing in a larger automated system wherein the production of the reduced data set event log is only one step in the production of a useful report.

The above-described base functions comprise an ordered listing of executable instructions for implementing logical functions. The ordered listing can be embodied in any computer-readable medium for use by or in connection with a computer-based system that can retrieve the instructions and execute them. In the context of this application, the computer-readable medium can be any means that can contain, store, communicate, propagate, transmit or transport the instructions. The computer readable medium can be an electronic, a magnetic, an optical, an electromagnetic, or an infrared system, apparatus, or device. An illustrative, but non-exhaustive list of computer-readable mediums can include an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical). It is even possible to use paper or another suitable medium upon which the instructions are printed. For instance, the instructions can be electronically captured via optical scanning of the paper or other medium, then compiled, interpreted or otherwise processed in a suitable manner if necessary, and then stored in a computer memory.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A method of producing a reduced data set event log comprising the acts of:
(a) monitoring an event log comprising examination and series data from a digital imaging device; and
(b) automatically copying portions of the examination and series data from the event log to produce the reduced data set event log.

2. The method of producing a reduced data set event log, as set forth in claim 1, wherein the event log is produced from a computed tomography (CT) device.

3. The method of producing a reduced data set event log, as set forth in claim 1, wherein the event log comprises a multi-threaded event log.

4. The method of producing a reduced data set event log, as set forth in claim 1, wherein act (b) comprises:
(a) providing a feature extracter module;
(b) analyzing the event log using the feature extracter module; and
(c) storing portions of the examination and series data in the reduced data set event log.

5. The method of producing a reduced data set event log, as set forth in claim 4, wherein the feature extracter module comprises a software algorithm.

6. The method of producing a reduced data set event log, as set forth in claim 4, wherein the feature extracter module comprises a Programmable Read Only Memory (PROM) device.

7. The method of producing a reduced data set event log, as set forth in claim 4, wherein the feature extracter module comprises a software routine.

8. The method of producing a reduced data set event log, as set forth in claim 4, wherein the feature extracter module comprises a state machine.

9. A method of interpreting an event log comprising the acts of:
(a) using a state machine to describe predetermined conditions;
(b) switching states of the state machine in response to the detection of the predetermined conditions; and
(c) producing a reduced data set event log based on the output of the state machine.

10. The method of interpreting an event log, as set forth in claim 9, comprising the acts of:
manually inspecting exemplary event logs comprising examination records and series records;
identifying a plurality of text-strings corresponding to the examination records and series records;
assigning a condition to each of the plurality of text-strings; and
using each of the conditions to define a state machine.

11. A method for defining conditions for producing a reduced data set event log comprising:
manually inspecting exemplary event logs comprising examination records and series records;
identifying a plurality of conditions corresponding to the examination records and series records; and
using each of the conditions to define a state machine.

12. The method for defining conditions, as set forth in claim 11, wherein the conditions are correlative to a plurality of recognizable text-strings.

13. A system for interpreting an event log comprising:
an input device configured to produce an event log, the event log comprising imaging data correlative to an image scan; and
a feature extracter module configured to receive the event log from the input device and further configured to produce a reduced data set event log.

14. The system for interpreting an event log, as set forth in claim 13, wherein the feature extracter module comprises a software algorithm.

15. The system for interpreting an event log, as set forth in claim 13, wherein the feature extracter module comprises a state machine.

16. The system for interpreting an event log, as set forth in claim 13, wherein the event log comprises a multi-threaded event log.

17. The system for interpreting an event log, as set forth in claim 13, wherein the input device comprises at least one of a computed tomography (CT) device, a magnetic resonance imaging (MI) device, an x-ray system, and an ultrasound system.

18. A system for interpreting an event log comprising a computer comprising a feature extracter module, the module configured to receive an event log from an input device and further configured to produce a reduced data set event log.

19. A feature extracter module configured to receive an event log from an input device and further configured to produce a reduced data set event log.

20. The feature extracter module, as set forth in claim 19, comprising a software algorithm.

21. The feature extracter module, as set forth in claim 19, comprising a state machine.

22. The feature extracter module, as set forth in claim 19, wherein the event log comprises a multi-threaded event log.

23. The feature extracter module, as set forth in claim 19, wherein the input device is a computed tomography (CT) device.

24. A computer-readable medium storing computer instructions for:
monitoring an event log comprising examination and series data from a digital imaging device; and
automatically copying portions of the examination and series data from the event log to produce a reduced data set event log.

25. The computer-readable medium, as set forth in claim 24, wherein the computer instructions for automatically copying comprises computer examinations for:
analyzing the event log, and storing portions of the examination and series data in the reduced data set event log.

26. A tangible medium for storing a state machine comprising:
a routine for switching states of a state machine in response to the detection of the predetermined conditions; and
producing a reduced data set event log based on the output of the state machine.
